(19) United States
(12) Patent Application Publication
(10) Pub. No.: US 2016/0275470 A1
(43) Pub. Date: Sep. 22, 2016

(54) LOCATION REGULATED POINT-OF-SALE SYSTEM AND ENHANCEMENTS

(71) Applicant: MYQ, Inc., Urbandale, IA (US)

(72) Inventors: Thomas M. Straw, Urbandale, IA (US); Gregg M. Majewski, Hoffman Estates, IL (US); Gabe Jon Frobenius, Detriot Lakes, MN (US); Paul W. Bordeaux, West Fargo, ND (US); Daniel Patrick Leahy, Hanover, MN (US); Thomas E. Novick, Evanston, IL (US)

(21) Appl. No.: 14/984,131

(22) Filed: Dec. 30, 2015

Related U.S. Application Data
(63) Continuation of application No. PCT/US2014/000154, filed on Jun. 30, 2014.
(60) Provisional application No. 61/936,929, filed on Feb. 7, 2014.
(60) Provisional application No. 61/957,372, filed on Jul. 1, 2013.

(51) Int. Cl. G06Q 20/20; H04W 4/02

(52) U.S. Cl. CPC G06Q 20/20; H04W 4/02

(57) ABSTRACT

A location regulated POS system employs a customer POS subsystem and a provider POS subsystem connected by one or more networks. The customer POS subsystem is operated by a customer and the provider POS subsystem is operated by a provider of good(s)/service(s). In operation, the subsystems (1) conduct a transaction between the customer and the provider for the good(s)/service(s) as ordered by the customer (remotely or locally) from a provider location (stationary or mobile) for receipt of the good(s)/service(s) to the customer, (2) track a customer location (stationary or mobile) relative to a preparation time zone encompassing the provider location, the preparation time zone for managing a preparation by the provider of the good(s)/service(s), and (3) identifies the customer location relative to the provider location for the receipt of the good(s)/service(s). Alternatively, the subsystems may (1) track the provider location (stationary or mobile) relative to a preparation time zone encompassing the customer location, the preparation time zone for managing a preparation by the customer for delivery of the good(s)/service(s) by the provider, and (3) identify the provider location relative to the customer location for the delivery by the provider of the good(s)/service(s).

The present application claims priority to International Application No. PCT/US2014/000154 filed Jun. 30, 2014, which claims priority to both U.S. Provisional Application Ser. No. 61/957,372 filed on Jul. 1, 2013, and U.S. Provisional Application Ser. No. 61/936,929 filed on Feb. 7, 2014. The entireties of which are hereby incorporated reference.

The present disclosure generally relates to point-of-sale (“POS”) systems. The present disclosure specifically relates to a utilization by POS systems of location technology (e.g., global positioning system (“GPS”), assisted GPS, network base station database, network triangulation (signal-strength based or time-based), beacon and hybrids thereof) for purposes of tracking a customer location and/or a provider location to facilitate an efficient and timely preparation and/or delivery by a provider of good(s) and/or service(s) remotely or locally ordered (i.e., requested, solicited, demanded, reserved, applied for etc.) by a customer.

### BACKGROUND OF THE INVENTIONS

Generally, a POS system employs hardware and software required to conduct a POS transaction between a customer and a provider of good(s) and/or service(s). Typically, the POS transaction sequentially includes (1) a description and cost of the good(s)/service(s) ordered by the customer, (2) a payment tender or commitment by the customer for the good(s)/service(s) (if applicable) that may include a verification of customer information, and (3) an approval by the provider of the payment tender and/or a confirmation by the provider of the customer order for receipt of the good(s)/service(s) by the customer.

More particularly, the specific hardware and software components of the POS system depend on the type of business conducted by the provider. For example, the POS hardware may include: (1) computer tower(s), monitor(s), laptop(s), tablet(s) and smartphone(s) specifically configured for the business; (2) display(s) for the customer to read; (3) card reader(s) if the business takes debit and/or credit cards; (4) keyboard system(s); (5) scanner(s); (6) receipt printer(s); and (7) cash drawer(s). Also by example, functionality of the POS software components may include: (1) sales and distribution; (2) manufacturing/assembly; (3) supplier/purchase order management; (4) inventory/material management; (5) total quality management; and (6) financial reporting. Additional hardware and software components may be added based on a complexity of the business structure.

U.S. Patent Application Publication 2013/0138515A1 to Taniguchi et al. describes an order receiving system that receives orders for items or services requiring preparation time for provision, and that is capable of supporting the start of preparation for items or services to be provided, at appropriate timing. The present disclosure addresses a failure of Taniguchi to provide a comprehensive POS system having a vast scope of functionality and applicability for providers of varying types of good(s) and/or service(s).

### BRIEF SUMMARY OF THE INVENTIONS

The present disclosure improves upon existing POS systems by a utilization of location technology (e.g., global positioning system (“GPS”), assisted GPS, network base station database, network triangulation (signal-strength based or time-based), beacon and hybrids thereof) for purposes of tracking a customer location and/or a provider location to facilitate an efficient and timely preparation and/or delivery by a provider of good(s) and/or service(s) remotely or locally ordered (i.e., requested, solicited, demanded, reserved, applied for etc.) by a customer.

For purposes of the present disclosure, a “customer” is broadly defined herein as any entity acting in any manner as a buyer, a purchaser, an investor, an acquirer, a beneficiary or otherwise consumer of good(s)/service(s) including, but not limited to, an individual person, a group of individuals and a business/corporation of any type, and a “customer location” is broadly defined herein as any location of the customer associated with conducting the transaction with the provider including, but not limited to, a physical location of the customer as a person or group of individuals or a site location for receipt by the customer of the goods(s)/service(s) (e.g., a dwelling, an office, a drop-off site, etc.).

For purposes of the present disclosure, a “provider” is broadly defined herein as any entity acting in any manner as a seller, a supplier, a donor, a contributor, a benefactor or otherwise provider of good(s)/service(s) including, but not limited to, an individual person, a group of individuals and a business/corporation of any type, and a “provider location” is broadly defined herein as any location of the provider associated with conducting a transaction with the customer for receipt of the goods(s)/service(s) by the customer including, but not limited to, a physical location of the provider as a person or group of individuals (e.g., a store, headquarters, office space, etc.) or a site location for delivery by the provider of the goods(s)/service(s) to the customer (e.g., an office, a warehouse, a pick-up site, etc.).

For purposes of the present disclosure, an “order” is broadly defined herein as any request solicitation, demand, reservation, application, etc. for good(s) and/or service(s) from a customer whereby the customer may or may not be required to pay for the good(s) and/or service(s). Examples of an “order” include, but are not limited to (1) an off-site order by a customer to a provider for food to be picked up by the customer from a provider location, (2) an off-site order by a customer to a provider for food to be delivered to a customer location by the provider, (3) an on-site order by a customer to a provider for food at the provider location, and (4) an off-site order by a customer to a provider for a reservation or appointment by the customer at the provider location.

One form of the inventions of the present disclosure is a location regulated POS system employing a customer POS subsystem and a provider POS subsystem connected by one or more networks. The customer POS subsystem is operated by a customer and the provider POS subsystem is operated by a provider of good(s)/service(s) of any type. In operation, the subsystems (1) conduct a transaction between the customer and the provider for the good(s)/service(s) as ordered by the customer remotely or locally from a provider location (stationary or mobile) for receipt of the good(s)/service(s) by the customer, (2) track a customer location (stationary or mobile) relative to a preparation time zone encompassing the provider location, the preparation time zone for managing a preparation by the provider of the good(s)/service(s), and (3) identifies the customer location relative to the provider location for the receipt by the customer of the good(s)/service(s).

Alternatively, the subsystems may (1) track the provider location (stationary or mobile) relative to a preparation time zone encompassing the customer location, the preparation time zone for managing a preparation by the customer for delivery of the good(s)/service(s) by the provider, and (3) identify the provider location relative to the customer location for the delivery by the provider of the good(s)/service(s).

Additionally, the subsystems may incorporate:

(1) a Location Aware Heartbeat process for generally monitoring a movement of the customer relative to an initial position of the customer location and/or a movement of the provider relative to an initial position of the provider location;

(2) a Variable Perimeter process for generally increasing an accuracy of the preparation time zone;

(3) a Token Hand-Off process for generally changing an initial customer location to a different customer location;

(4) a Remote Notification process for generally changing an initial provider location to a different provider location;

(5) a Location Aware Marketing process for generally transmitting information (e.g., messages, promotions, etc.) to the customer based on the customer location relative to the provide location;

(6) a Dine-In process for generally providing informational access of the good(s)/service(s) by the customer based on the customer location relative to the provider location;

(7) a Reservation/Check-In process for generally enabling the customer to place reservation at the provider location based on the customer location relative to the provider location;

(8) a Delivery process for generally notifying the provider to prepare delivery services based on the customer location relative to the provider location;

(9) a Snooze Process for generally enabling the customer to increase the preparation time zone;

(10) a Delivery Activated process for generally enabling the customer to designate the customer location as being different than the order location; and

(11) Order Screens for facilitating the aforementioned processes.

The foregoing forms and other forms of the present disclosure as well as various features and advantages of the present disclosure will become further apparent from the following detailed description of various embodiments of the present disclosure read in conjunction with the accompanying drawings. The detailed description and drawings are merely illustrative of the present disclosure rather than limiting, the scope of the present disclosure being defined by the appended claims and equivalents thereof.

### BRIEF DESCRIPTION OF THE DRAWINGS

FIG. 1 illustrates an exemplary working environment for a location regulated POS system in accordance with inventive principles of the present disclosure.

FIG. 2 illustrates a state diagram of the location regulated POS system illustrated in FIG. 1.

FIG. 3 illustrates an exemplary embodiment of the location regulated POS system illustrated in FIG. 1.

FIG. 4 illustrates a flowchart representative of a location regulated POS method in accordance with inventive principles of the present disclosure.

FIG. 5 illustrates a first exemplary embodiment of an order screen in accordance with inventive principles of the present disclosure.

FIG. 6 illustrates a second exemplary embodiment of an order screen in accordance with inventive principles of the present disclosure.

### DETAILED DESCRIPTION OF THE INVENTION

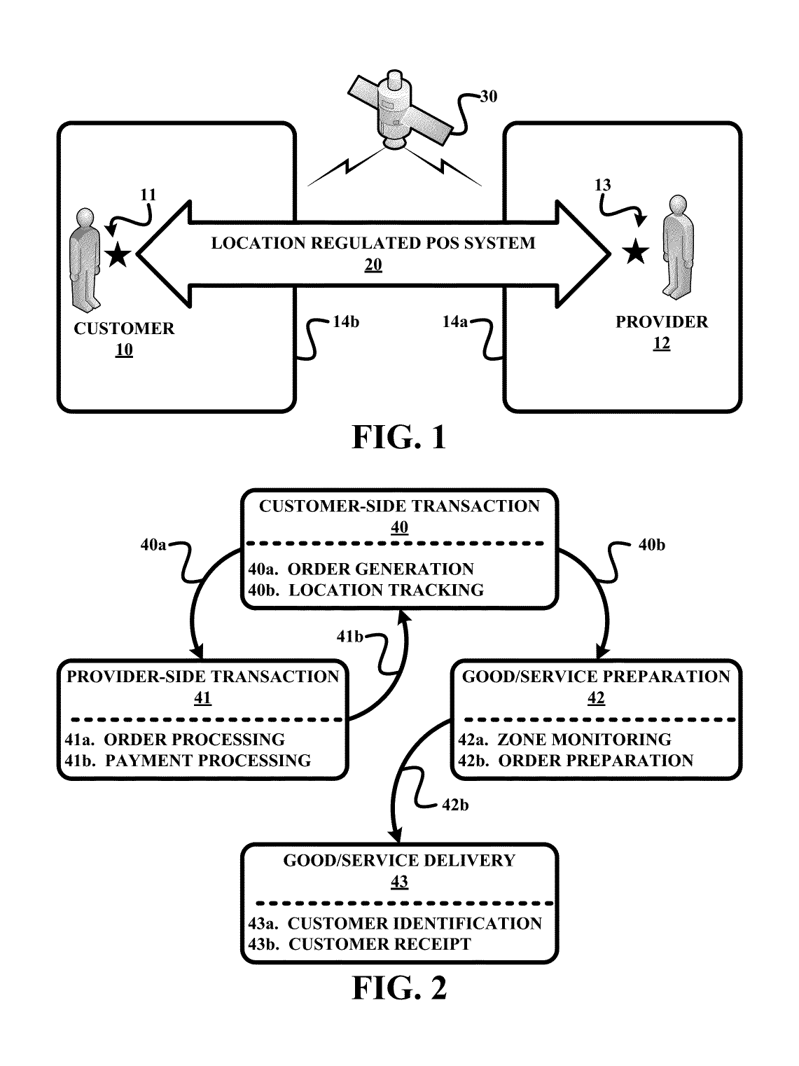

FIG. 1 illustrates a new and unique location regulated POS system 20 for facilitating an efficient and timely preparation and/or delivery by a provider 12 of good(s) and/or service(s) of any type whereby the good(s)/service(s) are remotely ordered by a customer 10. Generally, system 20 incorporates standard POS hardware/software components supplemented by hardware/software components of the present disclosure that exploit commercially available location technology 30 to conduct a transaction between customer 10 and provider 12 for the good(s)/service(s) as remotely or locally ordered by customer 10. In practice, customer 10 and provider 12 may have an affiliation associated with the transaction (e.g., different departments of a company) or may not have an affiliation associated with the transaction (e.g., a fast food consumer). Additionally, while location technology 30 as shown in FIG. 1 is symbolized as a GPS satellite, location technology 30 in practice may include, but not be limited to, GPS, assisted GPS, network base station database, network triangulation (signal-strength based or time-based), beacon and hybrids thereof.

Prior to or upon completion of the transaction, system 20 tracks a customer location 11 via location technology 30 relative to a preparation time zone 14a encompassing provider location 13 for the receipt of the good(s)/service(s) by customer 10 and/or tracks provider location 13 via location technology 30 relative to a preparation time zone 14b encompassing customer location 11 for the delivery of the good(s)/service(s) by provider 12. Preparation time zones 14a and 14b facilitate a respective preparation management by provider 12 of the good(s)/service(s) that allows for an efficient and timely receipt of the good(s)/service(s) by customer 10 responsive to an identification by system 20 of customer location 11 relative to provider location 13, or vice-versa (e.g., customer location 11 being adjacent to or coinciding with provider location 13). In practice, customer location 11 and/or provider location 13 are mobile and therefore the tracking of customer location involves movement by customer location 11 in a direction of provider location 13 and/or movement by provider location 13 in a direction of customer location 11.

More particularly to the preparation management, provider 12 is prompted by system 20 to initiate a preparation of the good(s)/service(s) upon customer location 11 being adjacent to or entering/within preparation time zone 14a as indicated by the tracked customer location 11, and/or customer 10 is prompted by system 20 to prepare for delivery of the good(s)/service(s) upon provider location 13 being adjacent to or entering/within preparation time zone 14b as indicated by the tracked provider location 13. In practice, a preparation time zone may be a vector, a two-dimensional plane of any perimeter and configuration, or a three-dimensional volume of any perimeter and configuration. Also in practice, a perimeter and/or a configuration (open or closed) of a preparation time zone 14 are defined by customer 10 and/or provider 12 in view of a variety of factors including, but not limited to, (1) a geographical location and structural layout of customer location 11 and/or provider location 13, (2) available route(s) and mode(s) of transportation by customer 10 to provider location 13 and/or by provider 12 to customer location 11, (3) a detected speed of customer location 11 in a direction of provider location 13 and/or a detected speed of provider location 13 in a direction of customer location 11, (4) daily and seasonal weather conditions associated with customer location 11 and/or provider location 13, and/or (5) historical and/or current production time of the good(s)/service(s) by provider 12. As such, each of the perimeter and the configuration of a preparation time zone 14 may be fixed or variable in dependence upon the variety of factors, and may be defined on a customer by customer basis. Additionally, in practice, customer location 11 may be located at any point within preparation time zone 14b (e.g., a center of preparation time zone 14b) and provider location 13 may be located at any point within preparation time zone 14a (e.g., a center of preparation time zone 14a).

FIG. 2 illustrates an exemplary state diagram of system 20 to facilitate a further understanding of system 20. The state diagram consists of a customer-side transaction state 40, a provider-side transaction state 41, a good/service preparation state 42 and a good/service delivery state 43. While the state diagram is applicable to preparation time zone 14a, those having ordinary skill in art will appreciate how to apply the state diagram or a modification thereof to preparation time zone 14b.

Referring to FIGS. 1 and 2, in execution, state 40 encompasses an order generation 40a involving customer 10 interacting with system 20 to remotely order the good(s)/service(s) over system 20 and in response thereto, state 41 encompasses an order processing 41a involving provider 12 interacting with system 20 to process the order in accordance with the business practices of provider 12. Prior to or upon settlement of the order, state 41 encompasses a payment processing 41b involving provider 12 interacting with system 20 to process a payment tender (e.g., cash or credit) by customer 10 in accordance with the business practices of provider 12. In practice, payment processing 41b may be concluded within state 41 or provisionally approved within state 41 for final approval during state S42 or state S43.

Upon payment or provisional payment approval, state 40 encompasses location tracking 40b by system 20 via location technology 30 of customer location 11 and in response thereto, state 42 encompasses a zone monitoring 42a by system 20 of customer location 11 relative to preparation time zone 14a statically or dynamically defined by system 20. If provider location 13 is mobile, state 42 further includes tracking by system 20 via location technology 30 of provider location 13.

Upon customer location 11 being adjacent to or entering/within preparation time zone 14a, state 42 encompasses an order preparation 42b being prompted by system 20 to provider 12 to thereby enable provider 12 to efficiently and timely manufacture, assemble, collect, acquire, start-up or otherwise prepare the good(s)/service(s) on behalf of customer 10.

Subsequent to prompting provider 12, state 43 encompasses a customer identification 43a by system 20 of customer location 11 being adjacent to or at provider location 13 for delivery of the good(s)/service(s) and a customer receipt 43b by system 20 of customer 10 receiving the goods(s)/service(s). In practice, customer identification 43a may be provided by location technology 30 indicating customer location 11 being adjacent or coinciding with provider location 13, and/or by any alternative identification technology as further described herein.

From the description of FIG. 2, those having ordinary skill in the art will appreciate system 20 for facilitating an efficient and timely preparation and/or delivery by a provider 12 of good(s)/service(s) for delivery to customer 10 at provider location 13 based on either preparation time zone 14a or preparation time zone 14b. Those having ordinary skill in the art will further appreciate system 20 for facilitating an efficient and timely preparation and/or delivery by a provider 12 of good(s)/service(s) for delivery to customer 10 at customer location 11 based on either preparation time zone 14a or preparation time zone 14b.

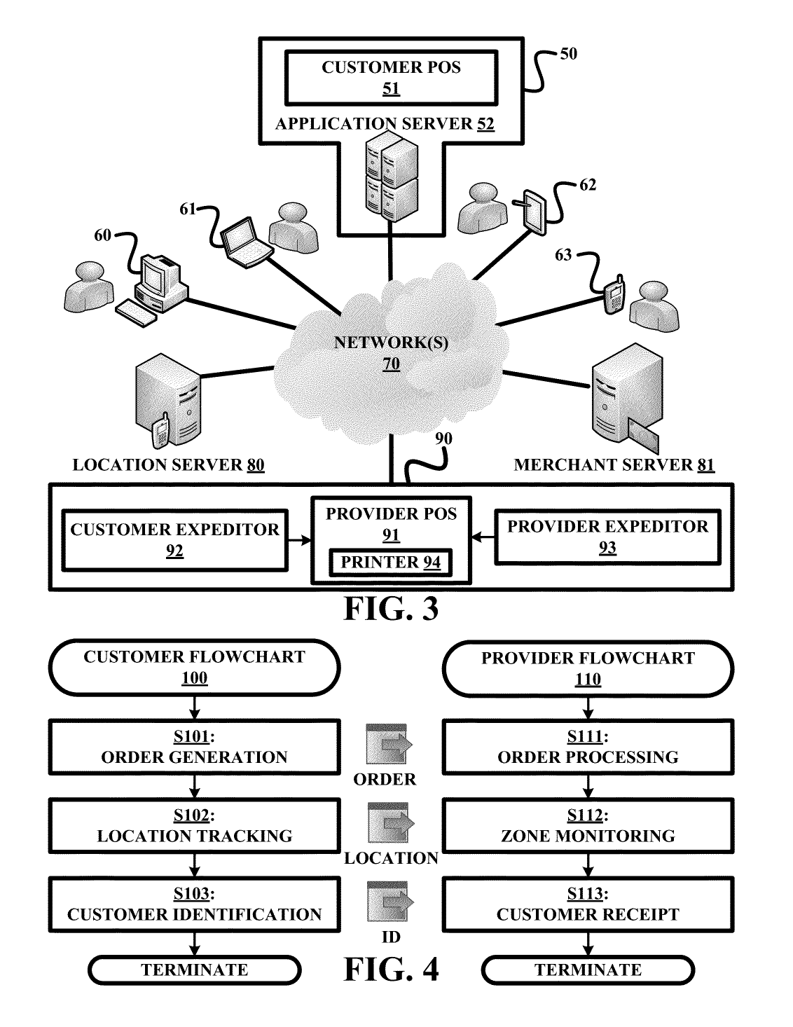

FIG. 3 illustrates an exemplary embodiment of system 20 for implementing the state diagram of FIG. 2 based on preparation time zone 14a. Nonetheless, those having ordinary skill in art will appreciate how to operate the illustrated embodiment of system 20 based on preparation time zone 14b.

Referring to FIGS. 1 and 3, the illustrated embodiment of system 20 distributes standard POS hardware/software components supplemented by hardware/software components of the present disclosure between a customer POS subsystem 50 and a provider POS subsystem 90 connected via one or networks 70 including, but not limited to, any telecommunication network (e.g., the Internet) and/or any radio network (e.g., a cellular network).

Specifically, customer POS subsystem 50 employs a customer POS application 51 and an application server 52. In practice, customer POS application 51 is installed on any type of computing device (particularly computing devices having location capabilities) and/or installed on application server 52 as a hardware, software, firmware and/or circuitry module for access by customer 10 via any type of computing device. Examples of such computing devices include, but are not limited to, a personal computer 60, a laptop 61, a pad 62, a mobile phone 63, a TV console/set-top box (not shown) and a vehicle dashboard (not shown). In practice, customer POS application 51 alternatively may be a stand-alone computing device.

In operation, customer POS application 51 is supported by application server 52 as necessary to facilitate an order generation by customer 10 of the good(s)/service(s). In one embodiment, customer POS application 51 is a stand-alone ordering application installed on the computing device(s) that communicates with application server 52 and/or provider POS subsystem 90 via network(s) 70. In a second embodiment, customer POS application 51 is one or more ordering website pages accessible by the computing device(s) on application server 52 and/or provider POS subsystem 90 via network(s) 70.

Also in operation, customer POS application 51 and/or application server 52 facilitate a tracking of customer location 11 (FIG. 1) based on location capabilities of the computing device(s) and/or a commercially accessible location server 80 connected to network(s) 70.

Provider POS subsystem 90 employs standard POS hardware/software components 91 (e.g., a printer 94) incorporating or running in conjunction with a customer expeditor application 92 and a provider expeditor application 93 of the present disclosure. In operation, component 91 processes the order generated by customer POS subsystem 50 including payment processing if applicable via a commercially accessible merchant server 81. Provider expeditor application 93 in the form of a hardware, software, firmware and/or circuitry module monitors customer location 11 relative to preparation time zone 14a to thereby provide a preparation prompt to provider 12 in response to customer location 11 being adjacent to or entering/within preparation time zone 14a. And, customer expeditor application 92 in the form of a hardware, software, firmware and/or circuitry module identifies or receives an identification of customer location 11 being adjacent to or coinciding with provider location 13 for the receipt by customer 10 of the good(s)/service(s). In one embodiment, expeditor applications 92 and 93 are viewable and/or programmable by provider 12 via computer systems of components 91, particularly to define preparation time zone 14a. In practice, expeditor applications 92 and 93 alternatively may be a stand-alone computing device(s).

FIG. 4 illustrates flowcharts 100 and 110 representative of a location regulated POS method of the present disclosure respectively implemented by customer POS subsystem 50 and provider POS subsystem 90 of FIG. 3. Specifically, customer POS application 51 and application server 52 cooperatively operate to execute flowchart 100, and provider POS 90 and expeditor applications 91 and 92 cooperatively operate to execute flowchart 110.

Referring to FIG. 4, a stage S101 of flowchart 100 encompasses customer 10 accessing customer POS application 51 to remotely or locally generate an order of good(s)/service(s) received via network(s) 70 by provider POS components 91, which in turns process the order during a stage S111 of flowchart 110 for standard confirmation by POS components 91 and payment/provisional approval if applicable via merchant server 81.

A stage S102 of flowchart 100 encompasses customer POS application 51 and/or application server 52 tracking customer location 11 via the computing device(s) and/or location server 80 and communicating customer location 11 to provider expeditor application 93, which in turn determines if the customer location 11 is adjacent to or entering/within preparation time zone 14a during a stage S112 of flowchart 110. In practice, provider expeditor application 93 may also track provider location 13 via location server 80 during stage S112, particularly if provider location 13 is mobile.

A stage S103 of flowchart 100 encompasses customer POS subsystem 50 identifying customer location 11 being located adjacent to or coinciding with provider location 13 and a stage S113 of flowchart 110 encompasses provider POS subsystem 90 executing a receipt of the good(s)/service(s) by customer 10 as practiced by provider 12. In practice, the customer identification may include, but not be limited to, customer 10 interacting with customer POS application 51 to notify provider POS subsystem 90 of the arrival of customer 10 at provider location 13, customer expeditor application 92 acknowledging customer location 11 is adjacent to or coinciding with provider location 13 via location server 80 and/or customer 10 interacting with an arrival system located at provider location 13 (e.g., a kiosk).

The following are descriptions of several scenarios of system 20 as shown in FIG. 3 implementing flowcharts 100 and 110 and variations thereof, particularly as to the pushing and pulling of information between customer POS subsystem 50 and provider POS subsystem 90.

The first example involves a customer working downtown and desires to order a sub sandwich from a local deli fifteen (15) minutes away from his/her office. The customer generates the order on an application (e.g., application 51 of FIG. 3) downloaded onto his/her mobile computing device (e.g., a mobile phone 63 of FIG. 3), and the local deli accepts the order and processes payment, which is confirmed by the customer via the application. The local deli has a preparation time of ten (10) minutes for the sub sandwich and based on a location tracking of the customer relative to the preparation time zone, the local deli will be notified when the customer is approximately ten (10) minutes from the local deli to initiate preparation of the sub sandwich. Upon arrival at the local deli, the customer via the application is identified via an “I am here” button and is provided a timely made and paid for sub sandwich.

The second example involves a suburban “soccer parent” customer who desires to feed six (6) children as the end of soccer practice nears. The pizza shop is twenty (20) minutes from the soccer fields en route to the customer's home. The customer generates the order via an application (e.g., application 51 of FIG. 3) downloaded onto his/her mobile computing device (e.g., mobile phone 63) and the pizza shop accepts the order and processes the payment, which is confirmed by the customer via the application. The pizza shop has a preparation time of fifteen (15) minutes for this order and based on a location tracking of the customer relative to the preparation time zone, the pizza shop will be notified when the customer is fifteen (15) minutes from arriving to initiate the preparation of the order. Because this is a substantially large dollar amount order and the pizza shop does not want the customer disappointed with cold pizza due to an unexpected delay by the customer, a confirmation of the order is sent via the application to the customer's mobile computing device at seventeen (17) minutes. The customer must reply in the affirmative via the application for the pizza shop to begin production of the order. Upon arrival at the pizza shop, the customer is identified via the application and is provided a timely made and paid for pizza order.

The third example involves a traveling business person in an unfamiliar city who desires a meal of unknown origin. The business person activates via voice control an application on the navigational system of his/her moving automobile stating “I'm Hungry”. The application identifies seven (7) quick-service food establishments within fifteen (15) minutes of the customer that utilize a location regulated POS system of the present disclosure (e.g., application 51 of FIG. 3). Via voice interaction with the application, the customer makes the selection and generates the order via the application on the navigational system and the provider accepts the order and processes payment, which is confirmed by the customer via the application. The provider determines via location tracking of the customer relative to the preparation time zone that the customer is only seven (7) minutes from the provider. The provider begins immediate preparation of the customer's order as production time is typically eight (8) minutes. Upon arrival at the provider location, the customer via the application is identified and is provided a timely made and paid for meal.

The fourth example involves a young urban professional on his/her way to work in the morning via his/her routine morning commute route. The customer desires his/her particular specialty coffee drink on the way to the subway station. The customer while still in his/her apartment generates an order via an application (e.g., application 51 of FIG. 3) on his/her mobile computing device (e.g., pad 62 of FIG. 3), and the coffee shop accepts the order and processes payment, which is confirmed by the customer via the application. The coffee shop is at peak production due to the hurried time of the day. Thus, based on location tracking of the customer relative to the preparation time zone and the ability of the coffee shop to gauge daily and hourly time variations in its production of customer orders, today the local coffee shop begins preparation of the customer's order when the customer is nine (9) minutes from the provider location. Upon arrival at the coffee shop, the customer via the application is identified and is provided a timely made and paid for cup of specialty coffee.

The fifth example involves a family of four (4) ready to sit down for family movie night. The family desires a dinner of unknown origin. Utilizing an application (e.g., application 51 of FIG. 3) on the family's television via a set-top console connected to the customer's content provider, the family is able to locate the five (5) restaurants that utilize a location regulation POS system of the present disclosure to make delivery to the family's location. The family as a customer makes a selection and generates the order via the application on the television's console and the provider accepts the order and processes payment, which is confirmed by the customer via the application. The provider determines the location of the family and estimated time of delivery is sent to the family. The family now begins watching the movie and are kept apprised of the delivery time via location tracking on the delivery vehicle and the television's set-top console relative to the family's location. The customer is alerted via the application of the delivery vehicle's immediate proximity to the family's location, the movie is paused and the family is delivered a made and paid for meal.

The sixth example involves a mobile food service vehicle and its ability to alert its customers of its imminent arrival time at a prescribed, static location. The mobile food service vehicle sends via an application installed onto the mobile computing devices of its customers the estimated time of arrival at such location. Each customer via the application is able to generate an order and process the payment with the provider. The mobile food service vehicle is able to via location tracking relative to the preparation time zone alert its customers of its imminent arrival and provide a timely made and paid for meal to its customers for prompt pick up.

The seventh example involves a mobile service vehicle of a local cable provider and a customer seeking timely services at the customer's location of the technician located in the mobile service vehicle. The customer is given at the start of the day an estimated window of time of arrival of the mobile service vehicle at the customer's location. Via an application (e.g., application 51 of FIG. 3) on the customer's computing device (e.g., laptop 61 of FIG. 3) and a location tracking of the mobile service vehicle relative to the preparation time zone, the local cable provider is able to transmit via the application on the customer's computing device a time of arrival within ten (10) minutes of the mobile service vehicle's actual arrival at the customer location. Upon arrival at the customer location, the customer is provided with the services in a timely and efficient manner.

The eighth example involves a business traveler who just landed at an airport and is en route via a cab to his/her business-class hotel for the evening. The customer was given a mobile application to download by the provider at the time of confirmation of the hotel reservation. The application allows the customer to order room-service food remotely from the provider to be delivered to the customer at the hotel upon the customer's arrival to his/her room. Via the application (e.g., application 51 of FIG. 3) on the customer's mobile computing device (e.g., pad 62 of FIG. 3), the customer generates the order and the provider accepts the order and processes payment, which is confirmed by the customer via the application. The provider has a preparation time of forty (40) minutes and based on the location tracking of the customer relative to the preparation time zone via the application, the provider will be notified when the customer is forty (40) minutes from arrival to his/her hotel room. Upon arrival at the hotel room or shortly thereafter, the customer via the application is identified and delivered a timely made and paid for room-service meal.

The ninth example involves a working parent who is leaving his/her place of employment to pick up the youngest child at day care. The customer via an application (e.g., application 51 of FIG. 3) downloaded onto his/her mobile computing device (e.g., mobile phone 63 of FIG. 3) alerts the day care provider of his/her imminent arrival. The day care typically takes seven (7) minutes to prepare the child for parent pick up and based on location tracking of the customer relative to the preparation time zone, the provider will be notified when the customer is approximately seven (7) minutes from the day care site. Upon arrival at the day care center, the customer via the application is identified and provided the child in a timely manner.

The tenth example involves a customer leaving the office en route to the dry cleaners to pick up his/her dry cleaning order. The customer via an application (e.g., application 51 of FIG. 3) downloaded onto his/her mobile computing device (e.g., pad 62 of FIG. 3) alerts the dry cleaning provider of his/her imminent arrival and the dry cleaner accepts the order and processes payment, which is confirmed by the customer via the application. The dry cleaner has a preparation time of up to five (5) minutes and based on the location tracking of the customer relative to the preparation time zone the provider will be notified when the customer is approximately five (5) minutes from the dry cleaner to initiate preparation of the order. Upon arrival at the dry cleaners, the customer is identified via the application and provided a timely delivery of their clothing to the customer's car in the parking lot of the dry cleaners.

An eleventh example involves an assembly department and a supply department of a corporation. Specifically, the assembly department may order parts from the supply department and the time required for the supply department to deliver the parts to the assembly department is two (2) hours. With a preparation time zone of ten (10) minutes for the delivery of the parts by the supply department, the assembly department may conduct other business while awaiting a prompt that the supply department is adjacent to or entering the preparation time zone whereby the assembly department prepares as necessary for the delivery of the parts by the supply department. Alternatively, with a preparation time zone of thirty (30) minutes for the pick-up of the parts by the assembly department, the supply department may conduct other business while awaiting a prompt that the assembly department is adjacent to or entering the preparation time zone whereby the supply department prepares as necessary for the pickup/receipt of the parts by the assembly department.

Description will now be provided herein of various enhancements to system 20 of FIG. 1, particularly for POS subsystems 50 and 90 of FIG. 3. For these descriptions, (1) the term “Outline Perimeter” is synonymous to preparation time zones 14a/14b (FIG. 1) and is considered a polygon that surrounds a Point C; (2) the term “Point A” is synonymous with customer (ordering location) 11 (FIG. 1), which is a location of a user's location aware mobile device at the beginning of the entire process; (3) the term “Point B” is any point between Point A and Point C that crosses the threshold of the Outline Perimeter whereby once the user's location aware mobile device crosses this threshold point, then notification from the user's location aware mobile device is communicated to a server to initiate additional processes; and (4) the term “Point C” is synonymous with provider (receipt) location 13 (FIG. 1), which is the location and intended destination to where the location aware mobile device would be travelling, as well as the end location for the good(s)/service(s) that is being produced or made available, whereas the good(s)/service(s) being produced or made available may or may not be originally located and/or produced at the same location of Point C.

From the description of the enhancements, those having ordinary skill in the art will appreciate when and how to implement any necessary acts/steps within state(s) of stage diagram of FIG. 2, particularly for the stages flowcharts 100 and 110 of FIG. 4.

Location Aware Heartbeat.

In operation, the process of detecting movement and location of a customer, delivery person, or good(s)/service(s) is done so by using location aware technology in a device that is in possession of or attached to the customer, delivery person or mode of transportation used by the customer or delivery person.

In one embodiment of Location Aware Heartbeat, the customer places an order from a website or mobile device. Then, either at the time of the order or at a time when the order process is set to initiate (in the event of an order placed in an earlier time and/or day by a customer), this Location Aware Heartbeat embodiment involves the customer's location aware device activating a monitoring process of the location aware mobile device initial location at the time of the order placement or order activation and continuing to compare the current location with the initial location to ascertain when the current location deviates from the initial location by a set or variable distance. The set or variable distance is dependent upon other factors that include, but are not limited to (1) the urban density, city or region, (2) current distance from customer's location aware device to the intended destination, (3) time of the day, (4) day of the year, (5) customer profile and/or (6) customer selected settings.

An example is a customer who places an order (e.g. from home or from an office setting) and then when this customer leaves that location, the movement away from their initial location initiates a notification from their location aware mobile device to a web service and such information is useful to estimate the arrival of the customer at a location where the customer would pick up an ordered product.

In another embodiment of Location Aware Heartbeat, a connection test is initiated at a set or variable time after the Location Aware Heartbeat process begins. This process is intended to know that the device is still able to communicate with the web services. This process could originate as a notification from the location aware mobile device to the web service, and/or a request from the web service to the location aware mobile device.

In another embodiment of Location Aware Heartbeat, communications between the customer's location aware mobile device and the web service are executed at different time intervals or on a consistent basis to ascertain different variables. When calculating travel speed, a consistent or fast and repetitive communication process would allow for an accurate travel speed calculation. When monitoring movement of a customer's location aware mobile device over a distance that is known to be longer (e.g., if the customer has ten (10) miles to travel before reaching the Variable Perimeter) then a slower repetition of communication would be used between the web service and the customer's location aware mobile device. If the customer is very close to the Variable Perimeter, then a faster repetition of the communication would be used between the web service and the customer's location aware mobile device. This variable allows the location aware processes to be less intensive at times when the next target destination goal, which would initiate additional web service actions, is already estimated to occur at an interval of time that is sufficient to not require consistent use of the location aware services of the location aware device and thus potentially saving on power and resources for the location aware device.

In another embodiment of Location Aware Heartbeat, the previous embodiment is modified whereby the repetition of the communication between the web service and the customer's mobile device remains consistent throughout the entire process.

In another embodiment of the Location Aware Heartbeat, the entire process listed in the preceding two paragraphs applies to the mobile device used to monitor the good(s)/service(s) in a delivery scenario whereby the good(s)/service(s) is being delivered to the customer.

Variable Perimeter.

This is a polygon perimeter surrounding a specific location (Point C) in three dimensional space whereas penetration of this perimeter would be Point B, and penetration would initiate notification to a web service of said penetration. More specifically, the Variable Perimeter addresses a need to increase a higher level of accuracy to the goal of providing good(s)/service(s) that has completed production at or near the same time that the user who ordered said good(s)/service(s) arrives at the location to pick up said good(s)/service(s) and is done so by expanding and/or contracting the polygon perimeter size surrounding Point C based upon factors of the provider and customer who ordered from the provider.

For purposes of the present disclosure, a “user” is broadly defined herein as any entity (e.g. customer or provider or delivery person) using a location aware device that is utilizing the location aware heartbeat whereas the location aware heartbeat is defined within this present disclosure.

Factors that could adjust the Variable Perimeter include, but are not limited to, (1) the user mode of transportation (e.g. walking or driving would affect how fast the user's location aware mobile device is moving), (2) the user direction of transportation (e.g. the user's location aware mobile device changes direction) either away from Point C or in such a manner that would require a new calculation of travel path that would change Point B, (3) how busy and how many orders are currently in process at the business that is to receive the notification, (4) other external factors that could affect the transportation time of the user and the user's location aware mobile device (e.g. rush hour, weather, construction), and (5) the variable of different production times of different good(s)/service(s) by the business.

Accordingly, needs exist to add variables and algorithms to the overall process to create an accurate forecast of the time when a user's location aware mobile device will arrive at a destination. Furthermore, that arrival would coincide with the availability of the product(s) and/or information at that same destination. The user's location aware mobile device is tracked and/or the user's location aware mobile device actively submits location information to a server whereas the server calculates the information for the purpose of forecasting the arrival time of the user's location aware mobile device to Point C.

The Outline Perimeter exists as an element of time whereas to provide a transfer of information that would initiate the production or availability of good(s)/service(s) with the intent that the good(s)/service(s) completes production and/or availability and is available at the Point C location at a time that is as close as possible to the moment that the user's location aware mobile device arrives at the destination of Point C.

The Outline Perimeter exists as both (1) an element of time that is based upon the variable production and/or availability times of one or more good(s)/service(s) and (2) an element of time that is based upon the forecast travel time of the user's location aware mobile device from Point A to Point C. Specifically, the forecast travel time of the user's location-aware mobile device from Point B to Point C is intended to match the time it takes for the information to transmit from the user's location aware mobile device to a computer or person that in turn initiates the process of good(s)/service(s) production and/or availability of good(s)/service(s) that has the end goal to be available at Point C. The transmission of information from the user's location aware mobile device to the computer or person that initiates the good(s)/service(s) production and/or availability could be direct or travel through additional resources.

In one embodiment of Variable Perimeter, the Outline Perimeter is manually adjusted to allow for different travel times due to landmarks and other travel time differences that would occur from different incoming directions of travel to Point C from numerous potential locations that could exist of Point A.

In another embodiment of Variable Perimeter, the Outline Perimeter expands and contracts, thus changing the location of Point B, based upon a list of factors that are ascertained by communication with a computer system (e.g., a restaurant POS system) that exists for Point C. This list of factors include, but are not limited to (1) the number of order requests that currently exist within a specific timeframe, (2) current staffing information that could affect production time tables and (3) good(s)/service(s) production times for different good(s)/service(s).

In another embodiment of Variable Perimeter, the Outline Perimeter expands and contracts, thus changing the location of Point B, based upon a list of factors that are ascertained from a database when a direct connection with a computer system that exists for Point C is not available (e.g., if a restaurant does not use a POS system or if the restaurant's POS system is not advanced enough to provide automated feedback). The factors that are ascertained include, but are not limited to (1) a database of good(s)/service(s) production times (that is compared to the good(s)/service(s) that was ordered and/or requested by the user and the user's location aware mobile device), (2) a database of busy time periods (e.g., lunch rush, evening rush, etc.) or slow times periods for Point C whereas specific days of the week, holidays, specific days of the month or year, times of the day or times of specific days are pre-defined as having a value that is higher or lower in average good(s)/service(s) production completion times.

In another embodiment of Variable Perimeter, the Outline Perimeter expands and contracts, thus changing the location of Point B, based upon a potential factor that the good(s)/service(s) production does not specifically occur at the specific Point C but rather at a separate location and therefore the travel time between the point of good(s)/service(s) production and Point C are included into the overall algorithm.

In another embodiment of Variable Perimeter, the size of the Outline Perimeter expands and contracts, thus changing the location of Point B, based upon a list of factors that are ascertained by a series of consecutive location calls between the user's location-aware mobile device and a server. The factors that are ascertained include, but are not limited to (1) the speed of transportation, (2) direction of transportation or (3) change in transportation path.

In another embodiment of Variable Perimeter, the entire process is affected if the direction of travel of the user's location aware mobile device were to change to a direction that is travelling away from Point B and/or Point C. Under such situations, new travel pathways and potentially a new Point B is calculated.

In another embodiment of Variable Perimeter, the size of the Outline Perimeter expands and contracts, thus changing the location of Point B, based upon a list of factors that are ascertained by third party services that provide travel information. The list of ascertained information includes but is not limited to (1) weather conditions, (2) travel density (i.e. “rush hour”), (3) accident delays, (4) road construction, (5) or other potential travel delay situations that a third party travel service could provide.

Token Hand-Off.

This process is essentially a location aware device hand-off of customer token for the purpose of changing the device that is location aware and holding onto the Location Aware Heartbeat process for an order.

In one embodiment of the Token Hand-Off, a customer placed an order through a website or mobile device and then the customer is able to use that same device to initiate a request to transfer the credentials of the person who is to pick-up the order, receive the order by delivery, or arrive to use a reservation or check-in as the order intended.

In another embodiment of Token Hand-Off, the person who placed the order or request using a computer or mobile device is not the same person who arrives at Point C to pick up the good(s)/service(s), however the same intended mobile device that originally had the Location Aware Heartbeat assigned, is the same, yet the person authorized to complete the process is different.

In another embodiment of Token Hand-Off, the person who placed the order or request using a computer or mobile device is not the same person who arrives at Point C to pick up the good(s)/service(s). The person travelling to pick up the good(s)/service(s) or is to receive an order by delivery or is travelling to use a reservation or check-in as intended by the order, is in possession of a different computer or mobile device then the computer or mobile device that was used to place the order and/or request for the good(s)/service(s). Under these circumstances there are two potential solutions for the order and/or information receipt, order confirmation and/or authorization screen and/or other display information that would suffice as record of authorized pick up, delivery or use of reservation or check-in of the good(s)/service(s) that was ordered and/or requested. First, the order and/or information receipt could be passed from the original computer device that placed the order using a “push” method whereas another user device is selected and/or entered on the original computer device and thus assigned from the original computer or mobile device to the new computer or mobile device. Alternatively, the order and/or information receipt could be passed from the original computer or mobile device that placed the order using a “pull” method whereas another user device submits a request via a program so it would be the new designated computer or mobile device to pick-up, receive by delivery, or use a reservation or check-in of the intended good(s)/service(s) ordered by the original computer or mobile device.

Remote Notification via Printer or Display Device.

This process involves a remote notification via printer or display device based upon a location aware mobile device crossing the threshold of an outline perimeter. This remote notification concerns the information notification to a business or entity when a location aware mobile device crosses a specific outline perimeter threshold of the present disclosure and access into a POS system 20 (FIG. 1) is not available within the business that accepts the orders that are to initiate the good(s)/service(s) production and/or readiness process that in turn completes the end goal of providing good(s)/service(s) at Point C that was ordered and/or requested by a customer. The remote notification provides a solution of placing the order and/or request into the hands of, or available for display to, the person who is responsible for initiating the good(s)/service(s) production and/or readiness process.

Generally, Point C is where the user's location aware mobile device and the completed good(s)/service(s) connect geographically. A printer or display device would not necessarily be located at Point C nor would it necessarily be located at the location of good(s)/service(s) production and/or readiness (whereas the location of good(s)/service(s) production and/or readiness could or could not exist at the same location of Point C). The location of the printer or display device is important to exist at such a location to provide the order in a printed or display format to a person who is responsible for initiating the good(s)/service(s) production and/or readiness process.

In one embodiment of Remote Notification via Printer or Display Device, a printer and/or display device receives data from a server whereas the server maintains order and/or request information that is calculated based upon the present disclosure, particularly Variable Perimeter, that applies to good(s)/service(s) ready date/time that is selected by the user.

In another embodiment of Remote Notification via Printer or Display Device, a printer and/or display device receives data from a server whereas the server maintains order and/or request information that is calculated based upon the present disclosure that applies to the intention of good(s)/service(s) being available and/or fully prepared at a time that coincides with the arrival of a customer's location aware mobile device to Point C.

In another embodiment of Remote Notification via Printer or Display Device, the printer and/or display device is connected to a local network.

In another embodiment of Remote Notification via Printer or Display Device, the printer and/or display device is connected via an independent mobile device that utilizes a mobile connection that is independent from the Internet or data connectivity of the business establishment within which the printer and/or display device is located.

In another embodiment of Remote Notification via Printer or Display Device, the printer queue is monitored remotely, by a program and/or a person, for the purpose of ascertaining the status of print jobs, printer jams and/or printer paper outages.

In another embodiment of Remote Notification via Printer or Display Device, a display device is monitored remotely, by a program and/or a person, to ascertain the active status of the display device.

In another embodiment of Remote Notification via Printer or Display Device, any status change or defined situation of the printer and/or display device could trigger an automated notification to an individual or another computer. For example, a robo-call could be automated to contact a restaurant if their printer queue was filling up because it is assumed that the printer may be out of paper or not working properly for any unknown or possible reason. Another example is if the printer or display device is no longer accessible via the independent mobile connection, an email or text message or robo-call or other form of communication could be sent to a restaurant to notify them that there may be a problem with the printer and/or display device.

Location Aware Marketing.

A website and/or mobile application that has a member base is capable of transmitting messages and/or promotions to members. Instead of transmitting messages and/or promotions to every member of the overall website and/or mobile app, Location Aware Marketing is a process of transmitting messages and/or promotions only to those members that are physically located within a specified distance from a specific location, or within a specified perimeter that surrounds a specified location, using the location aware information of the member's computing device that is to receive the message.

Typically, in order to submit messages and/or promotions to members of a website and/or mobile app, demographics are used to know which user should receive the promotion. This process uses the location of the member's mobile device to designate if and/or when the message would be delivered to the member. Furthermore, additional demographics could also apply to the algorithm that calculates if and/or when the member receives the message.

In one embodiment of Location Aware Marketing, a message is submitted to all members of a mobile app or website whereas the devices that display the message are only those devices that are located within a specified distance outline of a specified location or within a specific location that is defined by a polygon. The specified distance outline or polygon coordinates would be specified by either an algorithm and/or specified by manual entry of an individual or individuals.

In another embodiment of Location Aware Marketing, members of a mobile app could manage settings that specify what messages or alerts they would like to display on their mobile device depending upon their location. For example, a member could choose to receive an alert when he or she is located within a specified distance (e.g., five (5) miles) of a specified business establishment name, franchise or category (e.g., Sushi restaurants). In another example, a member could choose to receive coupons and/or promotions from business establishments (e.g., hotels) that are of a specific name, franchise or category (e.g., five star hotels that have a pool) when the member is within a specified distance (e.g., twenty (20) miles) from that business establishment.

In another embodiment of Location Aware Marketing, members of a mobile app could manage settings that specify the types of messages they allow to be received from such a system as discussed within this overall process.

In another embodiment of Location Aware Marketing, business establishments could be alerted when a specified number of mobile app members are within a specified distance from their business establishment or any other location, when those members have alert requests that match a specific category and/or demographics that fit a specific list of requirements. For example, an American category restaurant could be alerted when a specified number of members (e.g., ten (10) members) are within a specified distance from the business establishment (e.g., ten (10) miles) and this alert could trigger notification to the restaurant and/or specific automated messages that are sent back only to those mobile app members specifically. The messages could furthermore be defined and customized in an automated manner, based upon additional demographic information of each member.

Dine-In Process.

Many restaurants and other business locations are already using tablets and/or other computer devices at the customer table to provide customers with ordering and/or menu information. There is a need for an alternate option to provide restaurants and other businesses with a lower entry cost for computer devices at each table. An option that would utilize the customer's mobile device would be a viable solution. Using the existing present disclosure to confirm that the user is at the business location in which the menu and/or good(s)/service(s) list is intended to be viewed and used for ordering, users would use their own mobile device to access the menu and/or good(s)/service(s) list for viewing, referencing and/or ordering.

In one embodiment of Dine-In Process, the location awareness of the device would validate that the device is at or near the business establishment.

In another embodiment of Dine-In Process, the location aware device would allow the location of the user to be pinpointed to a specific position within a specific business establishment and thereby removing the need for the customer to specify where he or she is located within the business establishment when they submit questions and/or requests and/or orders from their mobile device using the application provided for customer requests and/or orders. In the event that the user is moving throughout the business establishment at the time of data submission (push of data from the user's device) or data retrieval by a web service (pull of data from a web service to request data from the user's device), the current location of the user's location aware mobile device could be used for the purpose of notifying the business establishment personnel and/or staff of the user's current location (e.g., in a bar or club setting when a drink is to be delivered to wherever the customer is located) or the current location of the user's location aware mobile device could be overlooked due to the fact that the user's designated location (e.g., a customer's table) is the source of delivery of all good(s)/service(s). In the later description mentioned in the previous sentence, an example would be a customer who is currently in the restroom when delivery of food is queued. Even though the location of the customer is no longer at his or her designated table, the system is aware of the table based upon previous location designation. This previous location is designated as the customer's specified point of physical delivery of good(s)/service(s) due to a manual trigger performed by the business establishment's personnel and/or staff, and/or a trigger performed by the user, and/or a calculation that selected this location due to the amount of time that the user's mobile device was present at that specific location after logging into the mobile app or mobile website and initiating processes that correspond to that specific business establishment.

In another embodiment of Dine-In Process, customers would scan a QR Code or barcode or enter an alpha-numeric statement into a mobile device and/or tablet device that includes a mobile website and/or mobile app. This statement entered would identify the table and/or location of the user/customer within the business establishment.

In another embodiment of Dine-In Process, customers would not scan or enter any data and instead a representative of the business establishment would manage the location information of the order as it applies to the business establishment's internal data of order management.

In another embodiment of Dine-In Process, all activities and information submitted by customers via the device would be saved into a database with the potential to submit directly into a central database system that exists at the business establishment (e.g., a restaurant POS system).

In another embodiment of Dine-In Process, users/customers would be able to request service from a representative of the business establishment (e.g., a waiter or waitress) for service (e.g., requesting a drink refill or requesting condiments) using the program that runs from the user's mobile device while the user is at the same said business establishment. The trigger of the request by the user who is using the program would trigger a notification to the business establishment whereas the notification could be set to send to a designated customer service representative (e.g., the waiter or waitress assigned to that user/customer, whereas the designation of said customer service representative is created by someone within the business establishment) or the notification could be automatically sent to the business establishment's staff member that is the closest to the user/customer when said staff member falls within a specific category under the business establishment whereas the category could be (1) all or, (2) for example, a category of waiters/waitresses or hosts/hostesses or bartenders, or (3) other, or the notification could be automatically sent to multiple staff members whereas the staff members are selected by other criteria that include, but are not limited to, the location of those staff members.

In another embodiment of Dine-In Process, an electronic data collection device would use within the business for the purpose of scanning or input of data when each good(s)/service(s) has completed the preparation phase and is ready to either be picked up by the user/customer or ready to be delivered to the user/customer. This data could be used for the purpose of: (1) notification to the customer for further instructions of good(s)/service(s) pick up, (2) notification of the customer that the delivery of the good(s)/service(s) is commencing or soon to commence, or (3) saving of this data into a database.

In another embodiment of Dine-In Process, all the previously mentioned embodiments could exist within a business model when the good(s)/service(s) preparation is performed at a location that is different from the business location where the user with the location aware device is located or intending to arrive (Point C).

In another embodiment of Dine-In Process, multiple users and/or customers at a business establishment could be placing one or more unique or similar orders and/or requests with the intent to have their good(s)/service(s) delivered and/or made available to them at a similar time while they are present at a similar location within that business establishment at the similar time. For example, a group intends to join together at a restaurant to have to a meal together. In this situation, one mobile device could be used to place orders and/or requests for good(s)/service(s) and that one mobile device could be used by one or more of the individuals within that group. Another option is that each group member could use his or her own mobile device to place his or her individual order and/or request for good(s)/service(s) with the option of two or more members within that group to share one mobile device for orders and/or requests for the same two or more members. Under these circumstances, the overall order and/or request of all individuals within this group could be made available to be viewed by all individuals of the same group due to a group designation that is assigned by the business establishment or assigned by the users/customers within the group itself, or assigned by the setting of the table designation process that existed by a manual statement, QR Code or barcode entry that originally start the order/request process.

In another embodiment of Dine-In Process, users and/or customers could view recent order preference statistics of the overall users and/or customers of the business establishment where the user and/or customer is located. These statistics display settings could be managed by the business establishment personnel and/or staff to control what information is available to the users and/or customers via the mobile website and/or mobile app.

In another embodiment of Dine-In Process, users and/or customers could view recent order completion time estimations of good(s)/service(s) based upon historical information that is available from the business establishment's POS or similar system.

In another embodiment of Dine-In Process, users and/or customers could select options such as the delivery and/or pick up and/or production preferences that include, but are not limited to the option to have good(s)/service(s) (1) delivered and/or made available for pick up for the users and/or customers as early as possible and when the individual good(s)/service(s) is available, or (2) delivered and/or made available for delivery and/or pick up for the users and/or customers as a smaller number of deliveries and/or pick-ups whereas each delivery and/or pick up includes a complete number of good(s)/service(s) that would provide a well-rounded and equal share of good(s)/service(s) to all those in attendance at the business establishment and also part of the same group. For example, customers could select to have their meals sent to their table as they become available or as one large delivery only when all meals are available for all those included within their group.

Reservation and Check-In Process.

When a service industry business allows registration for services (e.g. a restaurant accepting advance table reservations or a hair salon accepting appointments for a haircut) the process for appointments could be managed using the Location Aware Heartbeat process as defined herein.

In one embodiment of Reservation and Check-In Process, a customer places a reservation for an appointment for good(s)/service(s) and/or services from a business, in the example of a restaurant, this could be a reservation for a table. The customer selects the time that the customer desires to arrive at the business for the appointment or reservation. A database confirms the availability of that time before accepting the reservation. The Heartbeat process monitors the customer's location aware mobile device to ascertain the estimated arrival time of the customer to further refine the reservation and appointment priority list at the business to allow the expediting of other appointments or reservations before or after the customer in the event that the customer is going to arrive earlier or later than expected.

In another embodiment of Reservation and Check-In Process, the process is similar to the above with the difference in the customer selection of desired time for the appointment or reservation. The customer could select a time range of expected arrival instead of a specific time and the database would either return a specific time that is available or a time range that is available. Once selected, the Location Aware Heartbeat process takes over to monitor the customer's location aware mobile device location and ascertain if the customer will be on-time or early or late, thus allowing for additional adjustments within the reservation process to expedite other customers before or behind the original customer.

In another embodiment of Reservation and Check-In Process, the process is similar to the above except that the customer selects that he or she will be leaving their current location either now, or at a selected future time that is either a specific time or an interval of time in the future (e.g. I will be leaving in fifteen (15) minutes). The web service determines the estimated travel time from the customer's location aware device to the designated location for good(s)/service(s) or services, adds in the interval of time that the customer designated when he or she will be leaving the current location, then the web service calculates the estimated arrival time of the customer's location aware device to the desired destination. The database is checked for availability of appointments and/or reservations as the estimated time of arrival and the customer is informed if an appointment and/or reservation is available under the parameters the customer selected. If the customer agrees, the appointment and/or reservation is initiated into the web services for the destination business. For example, a customer could select that she is able to leave in twenty (20) minutes. The restaurant or business that is desired for an appointment and/or reservation is known by the web service to have (in this example) a twenty-five (25) minute travel time for the customer to leave her current location and arrive at the restaurant or business location. Thus the web service is looking for reservation availability that is in forty-five (45) minutes.

In another embodiment of Reservation and Check-In Process, a customer could select a category or categories or one or more restaurants or businesses and then the customer would enter the time of intended departure or enter the interval of time, from the current time, in which the customer will be wanting or able to depart his or her current location (e.g. “I will be able or wanting to leave in twenty (20) minutes”). The web service would then calculate the travel time from the customer's current location (or other location, if the customer selects that this reservation or appointment is for a future time and/or day and thus the customer can enter the location where he or she will be located on that time and/or day) and the web service would be able to notify the customer of available reservations or appointments that are available for the category or categories or one or more specific restaurants or businesses in which the customer selected. Since each restaurant or business would be at a different location, the final destination times would be different and thus the customer is able to view available reservations and/or appointments based upon the time they want to depart his or her current location (or based upon how soon they know they want to depart).

Delivery Process.

When a delivery person is leaving one location with good(s)/service(s) and/or service with the intention to deliver the good(s)/service(s) and/or service to a customer, a location aware device monitors the delivery person's location and said device is either in possession of the delivery person or attached to the object used by the delivery person as a mode of transportation to complete the delivery to the customer. The location and movement of said location aware device initiates web service actions to save data into a database, send data to the restaurant or business and/or send data to other web services and to send notifications to the customer(s).

In one embodiment of Delivery Process, the good(s)/service(s) to be delivered is assigned to one or more delivery person's or selected by the delivery person as his or her choice to deliver that item.

In another embodiment of Delivery Process, if a delivery person is assigned good(s)/service(s) or order to deliver (either because the delivery person made that choice or it was assigned to that delivery person by another person (e.g. a manager or supervisor) or assigned to that delivery person automatically by the application) and the delivery person is not currently located at or near the location where the good(s)/service(s) originates, then the delivery person would receive notification of the good(s)/service(s) delivery details from a web service via a location aware mobile device. The notification could occur instantly or the notification could commence based upon the location of the delivery person. For example, when the delivery person is returning to a restaurant, the application would recognize the location of the delivery person as having returned to the provider location and therefore the application would submit a notification message to the delivery person.

In another embodiment of Delivery Process, notification to the business of order preparation initiation would occur at such a time that is estimated that the good(s)/service(s) would complete production at a time that corresponds as close as possible to the time when the delivery person (who is assigned to be the delivery person of this new order) would return to the location where the good(s)/service(s) is being produced. This process is known because the delivery person is utilizing the Location Aware Heartbeat process defined within this document. For example, a pizza order that is expected to take fifteen (15) minutes to prepare, would have notification of order sent to a restaurant when it is estimated that the delivery person will be returning to the restaurant within fifteen (15) minutes.

In another embodiment of Delivery Process, order information sent to the business would list the production time to start at a time that is estimated whereas the completed good(s)/service(s) production time would corresponds as close as possible to the time when the delivery person (who is assigned to be the delivery person of this new order) would return to the location where the good(s)/service(s) is being produced. This is very similar to the previous paragraph except that the order preparation beginning time is listed as a future time and in the previous paragraph the notification sent to the business and/or restaurant is the notification to begin preparation.

In another embodiment of Delivery Process, after a delivery person is assigned good(s)/service(s) to deliver and the delivery person is located at or near the good(s)/service(s) origin location, then the movement of the delivery person's location aware device (that is either in possession of the delivery person or attached to the delivery person's mode of transportation) would activate a message to the web services to designate the good(s)/service(s) as “out for delivery”.

In another embodiment of Delivery Process, the oldest order is automatically set as the first order that the delivery person will be taking out on delivery. The order of delivery is set as oldest order first, then next oldest, then newest orders last.

In another embodiment of Delivery Process, the ideal route, as recommended by web service location and direction systems, is calculated and the mileage of the ideal route per delivery and per order is saved.

In another embodiment of Delivery Process, the ideal route is available for print out for the delivery person to show the driver the ideal route and therefore the ideal mileage that should be used for each delivery.

In another embodiment of Delivery Process, once good(s)/service(s) has been designated as “out for delivery” and the delivery person only has that one delivery to make, a notification would be sent to the intended customer to notify the customer of the estimated time of arrival of the delivery.

In another embodiment of Delivery Process, a delivery person would have the ability to manage deliveries and add a time interval “buffer” to any delivery. For example, if the delivery person is aware that he or she must drive his or her vehicle to a gas station before completing the delivery, or if the delivery person is aware of other situations or reasons why the delivery will take longer than usual, the delivery person could select a buffer of time to the delivery, before leaving the good(s)/service(s) origin location, and that buffer time would be calculated into the notification message sent to the customer where the intended delivery will complete.

In another embodiment of Delivery Process, similar to the above paragraph, the delivery person would have the ability to manage deliveries and add a time interval “buffer” to one or more deliveries at any time, before or after leaving the location where the delivery was picked up by the delivery person and before the delivery person delivers the good(s)/service(s) to the customer. Such a buffer option would allow the driver to select a delay for one or more orders using a one button selection on an app.

In another embodiment of Delivery Process, another device could be used to manage the same settings of buffer and the sequence order for delivery. For example, a restaurant manager could log in to a device or computer to add a buffer for a delivery person or set the delivery sequence order for the delivery person if the settings were not made by the delivery person or if the manager wanted to override the settings already made by anyone else.

In another embodiment of Delivery Process, a delivery person may have two or more deliveries in his or her possession when he or she leaves the good(s)/service(s) origin location. In this event, the delivery person may select the sequence order of deliveries and thus allowing the web services to calculate the first delivery estimated arrival time and notify that customer of the estimated arrival time first. After the delivery person has arrived at the first delivery location, the customer of the second delivery location would be notified that their good(s)/service(s) is “on its way soon” and once the delivery person is moving away from the first delivery location the customer of the second delivery location would be notified of an estimated arrival time. This process would continue for a third and subsequent deliveries that are to commence during this same time interval when the delivery person is away from the good(s)/service(s) origin location.

In another embodiment of Delivery Process, similar to the previous embodiment, a delivery person may have two or more deliveries in his or her possession when he or she leaves the good(s)/service(s) origin location. In this event, the delivery person may select the sequence order of deliveries and thus allowing the web services to calculate the first delivery estimated arrival time and notify that customer of the estimated arrival time first. After the delivery person has arrived at the first delivery location, and this is where the difference is with the previous paragraph, no notification would be sent to the second delivery location customer and instead, the notification to the second delivery customer could be manually initiated by the delivery person or automated when the delivery person then leaves the first delivery location. This process would continue for a third and subsequent deliveries that are to commence during this same time interval when the delivery person is away from the good(s)/service(s) origin location.

In another embodiment of Delivery Process, a delivery person may not select which order he or she intends to deliver first when he or she has two or more orders to deliver. In this instance, the system will calculate the direction of the delivery person to estimate which delivery is in attempt and proceed with notifications if the delivery destinations are not within close proximity of each other and the travel path of the delivery person's location aware mobile device is directed towards one specific delivery location. In some cases, two or more destinations may be in the same similar area or in the same pathway that the delivery person is travelling. In these situations, customers would be notified that the delivery is en route and an estimated time range will be provided. If the delivery person uses the mobile device to update his or her delivery sequence intentions at any time during the delivery process, additional messages could be sent to the intended delivery customers with new estimated arrival times based upon the new information provided by the delivery.

In another embodiment of Delivery Process, a delivery person could send a message or select from a few pre-selected messages that could be sent to a customer. For example, a message could be “I'm here at the front desk” or other useful messages to assist the driver in the process of keeping the customer notified about the delivery process.

Snooze Process.

When an order is placed by a customer for pick up, there will be situations when the customer is already located within the Process Variable Perimeter. For example, if the good(s)/service(s) ordered by the customer would require the business or restaurant fifteen (15) minutes for production and the customer is located an estimated ten (10) minutes of travel time from the restaurant, the Snooze Process would be used because the good(s)/service(s) preparation should begin before the customer begins to depart from his or her original location.

For purposes of the present disclosure, the “Pickup Buffer” is broadly defined herein as an amount of time before the customer departs his or her current location, whereas the Pickup Buffer equals the good(s)/service(s) production time MINUS the travel time estimated that it will take for the customer to leave his or her current location and reach the good(s)/service(s) pick up destination. For example, if it is estimated that the customer travel time to the good(s)/service(s) pick up destination is ten (10) minutes and the good(s)/service(s) production time is fifteen (15) minutes, and the customer selects that he or she will be leaving his or her current location in fifteen (15) minutes from the current time, then a fifteen (15) minute countdown timer would commence yet the “Pickup Buffer” in this situation is five (5) minutes. When the customer is within five (5) minutes of the intended departure from his or her current location, the order should be sent from the web services to the restaurant or business with the intention that the business begins production of the good(s)/service(s) that the customer is to pick up.

In one embodiment of Snooze Process, and this is to apply to all processes included within this present disclosure, the travel time of the customer to the good(s)/service(s) pick up location or the travel time of a delivery person or the travel time of any location aware mobile device that utilizes the Location Aware Heartbeat process is calculated based upon travel times of various modes of transportation from the current location of the location aware mobile device to the destination. The travel time used for the Location Aware Heartbeat and all location aware processes for the present disclosure are decided either by using the customer selected default transportation setting (e.g., walk, bike, car) as it applies to all instances or specifically to one or more businesses selected by the customer, or by calculating the customer travel speed and ascertaining the mode of transportation based upon the travel speed, or by asking the customer to select the preferred mode of transportation.

In another embodiment of Snooze Process, the mode of transportation would be asked due to close proximity of the customer to the end destination when it would be logical that walking would be preferred over other forms of transportation. This situation would be very useful to the customer as well who may be travelling and in a new location and not realize how close he or she is located to the destination selected.

Instead of the ordering process requesting that the customer selects a time he or she intends to pick up the product, the customer is requested to select or enter how soon he or she is planning to leave his or her current location. If the customer selects that he or she is planning to leave immediately and he or she already is located within the Process Variable Perimeter, than the order would be sent by the web service to the restaurant or business immediately for the purpose of the order going into production.

In another embodiment of Snooze Process, the options given to the customer, for “how soon will you be leaving?” are affected by the Pickup Buffer time. If the Pickup Buffer time is five (5) minutes, an example scenario of options to a customer could be (but not limited to) options of “I will be leaving in one (1) hour, in thirty (30) minutes, or within the next ten (10) minutes”. If the customer selects “in one (1) hour” or “in thirty (30) minutes” then when the countdown time is close to the Pickup Buffer time of five (5) minutes, the customer would be given a notification and option to “snooze” and select a new time in the event that something changed and it will be a longer time before the customer will be leaving. This notification to the customer and option for the customer to make this choice would be provided with enough time for the customer to optionally select options before the Pickup Buffer time was reached and therefore the order is already sent to the business or restaurant with the intention to begin the good(s)/service(s) production. If the customer were to select a time of departure from his or her current location that was too close to the Pickup Buffer time (e.g., if the Pickup Buffer time was 8 minutes and the customer selected that he or she will be leaving his or her current location in ten (10) minutes) then there would be no notification message reminder to select the “snooze” option, however the customer could use the “snooze” option at any time before the countdown reaches the Pickup Buffer time.

Delivery Activated by Third Party Location Change.

There are some situations where a delivery is desired to occur to a location where the customer is not currently located. This could happen for a delivery planned in the future, a delivery planned for another person, or a delivery that is planned for current deployment when a person is planning to travel to the destination where the delivery is intended to reach.

In one embodiment of Delivery Activated by Third Party Location Change, a customer places an order for delivery and requests that the delivery occurs at a different location. For example, a customer could be at work and want to have food delivered to his or her home. The customer could select to have the delivery to occur after he or she arrives home. In this situation, the delivery order notification could be sent to the restaurant or business at a time that estimates that the delivery would coincide with a time that is on or after the time when the customer will arrive at the location where the delivery is intended to reach.

In another embodiment of Delivery Activated by Third Party Location Change, a delivery could be dependent upon the Process Token Hand-Off whereas the order could come from a location that is or is not also the location for delivery. The order itself could be assigned, using the Process Token Hand-Off, to another location aware mobile device whereas that device initiates the process of the order being sent to the restaurant or business based upon the estimated arrival time of this other location aware mobile device to the delivery location and the delivery of the good(s)/service(s) to arrive at the delivery location at a similar time. In this example, the good(s)/service(s) delivery could be specified by the customer to be after the other location aware mobile device arrives at the delivery location (if the person with the location aware mobile device would be the only person at the delivery location to accept the order) OR the customer could select to have the good(s)/service(s) delivered at or before the time that the other person with the location aware mobile device would arrive at the delivery location (if other people are already at the delivery location and prefer to coincide, as best as possible, the good(s)/service(s) delivery with the other person's arrival.

In another embodiment of Delivery Activated by Third Party Location Change, similar to the above paragraph, the customer could add in a buffer to the process, requesting that the delivery of good(s)/service(s) is to be made within a set time difference before the estimated arrival of the other person with the other location aware mobile device. For example, a customer could ask that the good(s)/service(s) delivery occurs approximately one hour before the other person arrives. If the distance of the other person to the delivery location is great enough, this would work well by using the Location Aware Heartbeat Process. If the distance of the other person to the delivery location is a travel time that does not allow this using the Location Aware Heartbeat Process, then the Snooze Process would be used.

In another embodiment of Delivery Activated by Third Party Location Change, two or more people with location aware mobile devices could be assigned the Process Token Hand-Off and therefore their movement of all those with the Process Token Hand-Off, to one location that is the intended delivery location, would activate the delivery good(s)/service(s) order to be sent to the restaurant or business. The activation of the order could be dependent upon the time estimations of when the last person would arrive at the delivery location or when a selected percentage of the people would have arrived at the delivery location.

Order Screen.

For online or app order and/or request processes, an easier way was needed for users to place an order and/or request when two or more orders needed to be submitted together yet have different labels or settings. For example, the situation of two or more people ordering food together from a restaurant and each person's food selections should be labeled separately for delivery or pick-up or dine-in.

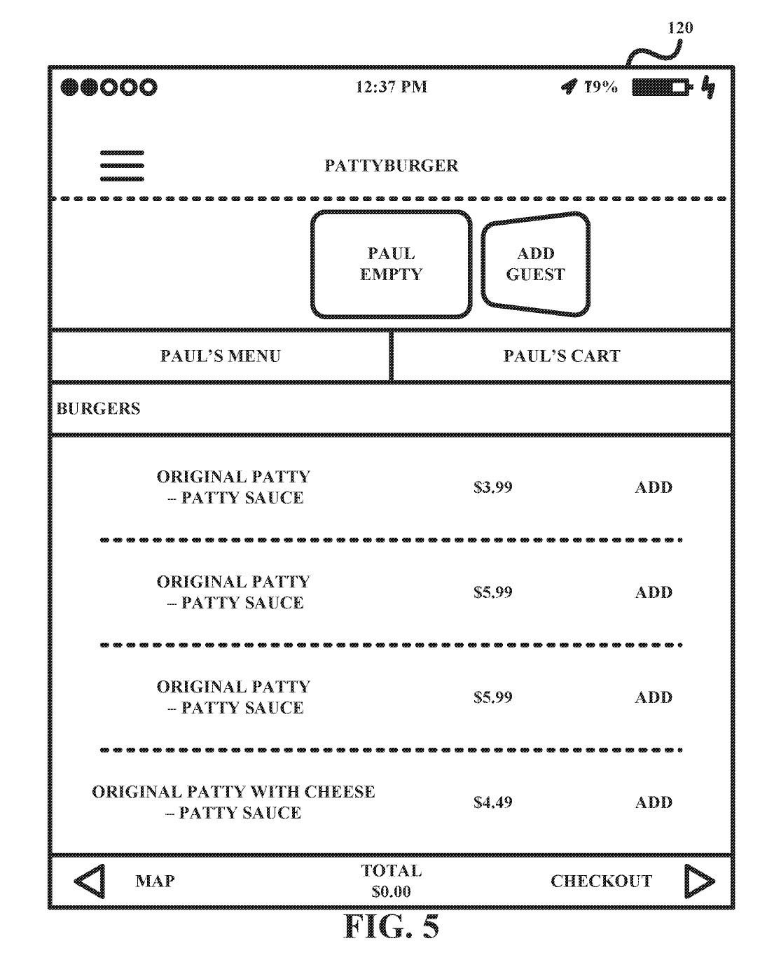

In one embodiment of Order Screen, a 3-D horizontally scrolling carousel menu exists on the same page as the good(s)/service(s) list on a website or an application whereas the user can select, view and manage all of the following from one website/app page interface: (1) separate sub-carts within the main cart (e.g., the sub-carts could be individual people who as a whole make up a group that is ordering food and each individual person has his or her food items entered into a sub-cart), and (2) items to add to their cart (e.g., a restaurant menu of food choices). FIG. 5 illustrates order screen 120 as an example of this embodiment of Order Screen.

In another embodiment of Order Screen, as the 3-D horizontally scrolling carousel menu rotates, the center selection of the 3-D horizontally scrolling carousel menu affects the information displayed in the menu and cart information that is located on the same website or application screen and/or page. Using order screen 120 of FIG. 5 as an example, when the 3-D horizontally scrolling carousel menu has Paul in the center, then the menu choices from the “Paul's Menu” tab affect the items placed into Paul's cart whereas the tab for “Paul's Order” displays the cart items that are only associated with Paul's choices while allowing interaction that includes, but is not limited to, the ability to edit or remove items from the cart.

In another embodiment of Order Screen, as the 3-D horizontally scrolling carousel menu rotates and the other display section on the same page/screen displays information and/or features that correspond to the center selection of the 3-D horizontally scrolling carousel menu. Selections on the page/screen affect the value displayed in the 3-D horizontally scrolling carousel items. Using order screen 120 of FIG. 5, if Paul is selected in the 3-D horizontally scrolling carousel menu and items are added to the cart from the “Paul's Menu” tab or items are added/removed from the “Paul's Order” tab, the total amount value display of that sub-cart is altered within the center selection within the 3-D horizontally scrolling carousel menu and a new price amount is listed in that location. This price value of Paul's sub-cart is displayed on this 3-D horizontally scrolling carousel menu item no matter which position it is at within the carousel.

In another embodiment of Order Screen, the sub-carts that are represented in the 3-D horizontally scrolling carousel menu could have additional sub-carts added using a separate selection within the 3-D horizontally scrolling carousel menu as an add feature. Using order screen 120 of FIG. 5, one image with a plus sign initiates a feature to allow the website or app user to add another sub-cart, in this case another person who is ordering food within the group order.

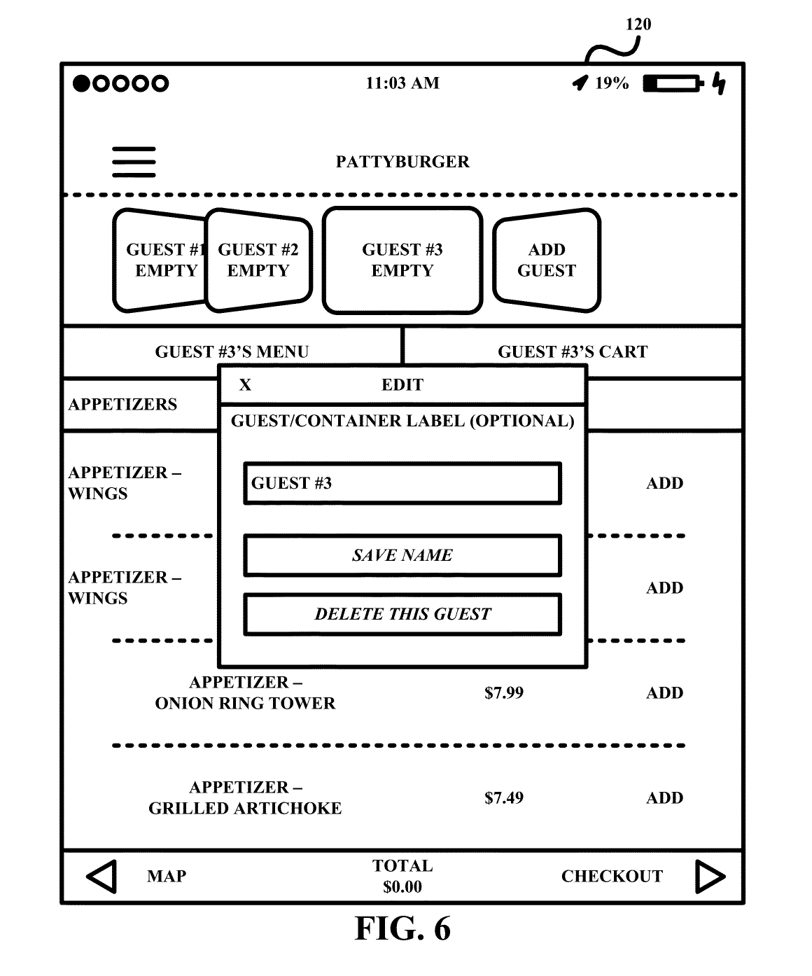

In another embodiment of Order Screen, each sub-cart within the 3-D horizontally scrolling carousel menu could be edited or deleted by the user of the website or app by selecting that item within the 3-D horizontally scrolling carousel menu. FIG. 6 illustrates order screen 121 as an example of this embodiment of Order Screen.

In another embodiment of Order Screen, the overall cart itself will still be ordered in one payment or ticket whereby a “ticket” is defined as a payment that may or may not be made in advance as it could be made when the order is delivered to the website or app user or when the user picks up the order or at some other point in the future that is arranged for payment in a mutually agreed date and/or time between the provider of the product(s) and the user who placed the order.

In another embodiment of Order Screen, the payment for the overall order will be split into separate payments in which two or more individuals or groups that make up the list of the sub-carts are sent payment requests and thereby provide payment for their part of one main order that is picked up or delivered as one overall order.

Although the present disclosure has been described with reference to exemplary aspects, features and implementations, the disclosed methods and systems are not limited to such exemplary aspects, features and/or implementations. Rather, as will be readily apparent to persons skilled in the art from the description provided herein, the disclosed systems and methods are susceptible to modifications, alterations and enhancements without departing from the spirit or scope of the present disclosure. Accordingly, the present disclosure expressly encompasses such modification, alterations and enhancements within the scope hereof.

1. A location regulated POS system, comprising:
a customer POS subsystem operable by a customer and a provider POS subsystem operable by a provider of at least one of a good and a service, the customer POS subsystem and the provider POS subsystem being connected by at least one network,
wherein the customer POS subsystem and the provider POS subsystem are structurally configured to conduct a transaction between the customer and the provider for the at least one of the good and the service as ordered by the customer from a provider location for receipt of the at least one of the good and the service by the customer,
wherein at least one of the customer POS subsystem and the provider POS subsystem are further structurally configured to track a customer location relative to a preparation time zone encompassing the provider location, the preparation time zone for managing a preparation by the provider of the at least one of the good and the service,
wherein at least one of the customer POS subsystem and the provider POS subsystem are further structurally configured to identify the customer location relative to the provider location for the receipt by the customer of the at least one of the good and the service, and
wherein at least one of an initial customer location is changeable to a different customer location and an initial provider location is changeable to a different provider location.

2. The location regulated POS system of claim 1, wherein the customer POS subsystem is further structurally configured to monitor a movement of the customer relative to an initial position of the customer location.

3. The location regulated POS system of claim 1, wherein the provider POS subsystem is further structurally configured to monitor a movement of the provider relative to an initial position of the provider location.

4. The location regulated POS system of claim 1, wherein the provider POS subsystem is further structurally configured to increase an accuracy of the preparation time zone prior to the transaction between the customer and the provider for the at least one of the good and the service.

5. The location regulated POS system of claim 1, wherein the provider POS subsystem is further structurally configured to increase an accuracy of the preparation time zone responsive to the transaction between the customer and the provider for the at least one of the good and the service.

6. The location regulated POS system of claim 1, wherein the provider POS subsystem is further structurally configured to provide informational access of the at least one good and the service by the customer based on the customer location relative to the provider location.

7. The location regulated POS system of claim 1, wherein the provider POS subsystem is further structurally configured to facilitate the transaction between the customer and the provider for at least one good and the service by the customer based on the customer location relative to the provider location.

8. The location regulated POS system of claim 1, wherein the provider POS subsystem is further structurally configured to notify the provider to prepare delivery services based on the customer location relative to the provider location.

9. The location regulated POS system of claim 1, wherein the customer POS subsystem is further structurally configured to enable the customer to increase the preparation time zone.

10. The location regulated POS system of claim 1, wherein the customer POS subsystem is further structurally configured to designate the customer location being different than an order location.

11. A location regulated POS system, comprising:
a customer POS subsystem operable by a customer and a provider POS subsystem operable by a provider of at least one of a good and a service, the customer POS subsystem and the provider POS subsystem being connected by at least one network,
wherein the customer POS subsystem and the provider POS subsystem are structurally configured to conduct a transaction between the customer and the provider for the at least one of the good and the service as ordered by the customer from a provider location for delivery of the at least one of the good and the service to the customer,
wherein at least one of the customer POS subsystem and the provider POS subsystem are further structurally configured to track a provider location relative to a preparation time zone encompassing the customer location, the preparation time zone for managing a preparation by the customer for the at least one of the good and the service, and
wherein at least one of the customer POS subsystem and the provider POS subsystem are further structurally configured to identify the provider location relative to the customer location for the delivery by the provider of the at least one of the good and the service.

12. The location regulated POS system of claim 11, wherein the customer POS subsystem is further structurally configured to monitor a movement of the customer relative to an initial position of the customer location.

13. The location regulated POS system of claim 11, wherein the provider POS subsystem is further structurally configured to monitor a movement of the provider relative to an initial position of the provider location.

14. The location regulated POS system of claim 11, wherein the provider POS subsystem is further structurally configured to increase an accuracy of the preparation time zone prior to the transaction between the customer and the provider for the at least one of the good and the service.

15. The location regulated POS system of claim 11, wherein the provider POS subsystem is further structurally configured to increase an accuracy of the preparation time zone responsive to the transaction between the customer and the provider for the at least one of the good and the service.

16. The location regulated POS system of claim 11, wherein the provider POS subsystem is further structurally configured to provide informational access of the at least one good and the service by the customer based on the customer location relative to the provider location.

17. The location regulated POS system of claim 11, wherein the provider POS subsystem is further structurally configured to facilitate the transaction between the customer and the provider for at least one good and the service by the customer based on the customer location relative to the provider location.

18. The location regulated POS system of claim 11, wherein the provider POS subsystem is further structurally configured to notify the provider to prepare delivery services based on the customer location relative to the provider location.

19. The location regulated POS system of claim 11, wherein the customer POS subsystem is further structurally configured to enable the customer to increase the preparation time zone.

20. The location regulated POS system of claim 1, wherein the customer POS subsystem is further structurally configured to designate the customer location being different than an order location.
